(19) United States
(12) Patent Application Publication
(10) Pub. No.: US 2003/0028543 A1
(43) Pub. Date: Feb. 6, 2003

(54) Image storage and reference using a URL

(76) Inventor: Dariusz T. Dusberger, Newport Beach, CA (US)

Correspondence Address: FITZPATRICK CELLA HARPER & SCINTO, 30 ROCKEFELLER PLAZA, NEW YORK, NY, 10112, US

(21) Appl. No.: 09/920,070

(22) Filed: Aug. 1, 2001

(51) Int. Cl. G06F 7/00

(52) U.S. Cl. 707/100

(57) ABSTRACT

The present invention concerns a resource locator which may be used to identify both an initial image, and an edited version of the initial image as well as the operations which can be applied to the initial image yields the edited image. The resource locator may further be used to generate an access key, and when a resource request is made using the resource locator, the access key may be used to validate the request.

### BACKGROUND OF THE INVENTION

1 Field of the Invention

The present invention relates to referencing digital images in cache or more persistent storage, wherein an image is referenced using a universal resource locator (UJRL). The URL providing a mechanism for referencing an initial image, the URL including a history of operations performed on the image, and the URL providing a mechanism for referencing an image that results from applying the operations to the initial image.

2. Description of the Related Art

Using a digital image capturing device such as a digital camera or a scanner, an image may be captured and made available for processing using a computer system. For example, an image processing application may be used to display and/or manipulate a digital image. A digital image may be manipulated, or edited, for example, to change the resolution or size, scale, crop, rotate, color correct, adjust brightness, adjust contrast, enhance, etc.

In a conventional approach, the image processing application executes on the same computer system as stores the digital image(s) to be processed by the application. However, it is possible for the digital image and/or the image processing application to reside on a remote computer system.

The internet (or WWW, World Wide Web 10) links computer systems such that a digital image may be transmitted between computer systems, and image processing operations may be performed on a local or remote computer system. A browser application is typically used to generate a user interface for access to the internet (or another network), send a request across the internet, receive a response, and display information within the user interface. Examples of browser applications include Microsoft's Internet Explorer and Netscape's Navigator.

A browser executes on a client computer system and communicates with a server computer system using an application-level communication protocol such as the Hypertext Transfer Protocol (HTTP). The browser may be configured to use other protocols such as the File Transfer Protocol (FTP) and the Simple Mail Transfer Protocol (SMTP). To display information on the client, the server sends a file that contains information used by the browser to generate, or modify, a display on the client. The information contained in the file is written in a language that is known to the browser such as the Hypertext Markup Language (HTML), another markup language (e.g., Extensible Markup Language, XML), or other language.

A Universal Resource Locator (URL) provides an addressing scheme that defines the route to a file or a program that the browser wishes to access. For example, the browser sends a URL to request a file that contains the information that the browser uses to generate a display page. The URL that is provided in the request typically identifies the server as well as the file. The URL may also be used to identify a particular application or program (e.g., a Common Gateway Interface, CGI, program) that is to service the browser's request. The URL also identifies the communication protocol, and may identify a port address of an application that executes on the server computer.

The following provides an example of a URL used to reference a file:

http://www.welcome_server.com/welcome.html

In the above example, the HTTP protocol is used to access the server at “www.welcome_server.com” to retrieve the file named “welcome.html” that contains the HTML statements used to generate a welcome page by the browser.

The HTML language defines the syntax for each of the HTML elements. An HTML element may include a URL as part of its definition in a file received by the browser. The URL providing a link to a resource such as another file. In such a case, as the browser parses the received file, it encounters the URL, and the browser uses the URL to retrieve the indicated file. The following is an example of an HTML “<IMG>” element that identifies a URL associated with a “gif” image file:

<IMG SRC=“http://www.image_server.com/images/hello.gif”>

When the browser encounters the “IMG SRC=” token, it recognizes that what follows is a location of a file that is to be retrieved and loaded at a specified position within the page that is being generated by the browser. The browser may look in its cache to determine whether a cached version of the “hello.gif” image exists locally. If not, it sends a request directed to “www.image_server.com” for the “hello.gif”. Upon receiving the request, the server accesses the “images” directory to retrieve the requested file and the “hello.gif” file is sent to the browser.

Typically, an image, whether it is an unedited or edited image, is identified by a name (e.g., “hello.gif”) that is generated by a file system. If an image is cached, it may be purged from cache to make room for another image. In such a case, if the image has not been edited, it may be retrieved using its file name, and provided as a response. However, if the only copy of the image that is being requested was the one in cache, and the requested image is the result of applying one or more operations to another image, any operations that were performed on the cached image must be repeated in order to respond to the request. In order to recreate the requested image, it is necessary that the operations be stored in some manner.

An image processing application may maintain a history of operations that have been performed on an image so that an operation (or operations) may be undone. In addition, the FlashPix file format provides for multiple resolutions of an image as well as a list of operations for manipulating one or more of the stored images.

However, there is no known mechanism for using a URL to maintain a list of operations and/or for using a URL to identify an unedited image, and (where applicable) an edited image.

Thus, it would be beneficial to be able to identify an image using a URL, wherein the URL identifies an image, regardless of whether it is an original or manipulated image. And, in the case of an edited image, the editing operations.

### SUMMARY OF THE INVENTION

The present invention addresses the foregoing problems and provides for a resource locator data structure which may be used to identify both an initial image, and an edited version of the initial image as well as the operations which can be applied to the initial image to yield the edited image. The resource locator may further be used to generate an access key, and a resource request that is made using the resource locator can be validated using the access key.

Advantageously, the resource locator facilitates access to images from either cache or persistent storage. A resource locator according to the present invention may be used to access an initial image as well as an edited version of the initial image. If the edited image is unavailable from storage (e.g., cache or persistent storage), the resource locator may be used to create the edited version.

In one embodiment of the invention, a resource locator data structure is provided for use by a computer system to request a stored image version, the data structure comprising a first portion which comprises an identifier for accessing a first version of an image, a second portion comprising a list of none or more operations, which when applied to the first image version yields a second version of the image, wherein a combination of the first and second portions identifies a requested image and the combination is used to determine whether the second image version exists in storage.

In another embodiment of the invention, a method for retrieving an image in storage using a resource locator is provided which comprises the steps of determining whether a requested image exists in storage, the requested image identified by information contained in the resource locator; and retrieving an initial image identified by the resource locator, and generating the requested image using the initial image and information contained in the resource locator, if the requested image is unavailable.

In yet another embodiment of the invention, a method is provided for referencing an image using a resource locator, the method comprising generating a first portion comprising an identifier associated with an image, the identifier referencing a first version of the image, generating a second portion comprising a list of none or more operations, which when applied to the first image version yields a second version of the image, wherein a combination of the first and second portions is used to reference the second image version when it is found to exist in storage.

This brief summary has been provided so that the nature of the invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is an outward view of a hardware environment embodying the present invention.

FIG. 2 is a block diagram of the internal architecture of a personal computer for use in conjunction with the present invention.

FIG. 3 provides an overview of the structure of an encoded URL according to the present invention.

FIG. 4 provides an example of an image processing client-server environment in which an encoded URL is used according to the present invention.

FIG. 5 illustrates a flow diagram of process steps to retrieve an image using encoded URL according to the present invention.

FIG. 6 illustrates a flow diagram of process steps to store an image with an associated encoded URL according to the present invention.

FIG. 7 illustrates a flow diagram of process steps in which a browser sends an image request using encoded URL to a server according to the present invention.

FIGS. 8A and 8B illustrate flow diagrams of process steps to generate an access key and to use the generated access key in validating a request according to the present invention.

FIG. 9 illustrates a flow diagram of process steps for use in an undo/redo operation using an encoded URL according to the present invention.

FIG. 10 shows an example of operation history and operations list information for use in an undo/redo operation according to the present invention.

### DETAILED DESCRIPTION OF THE PREFERRED EMBODIMENTS

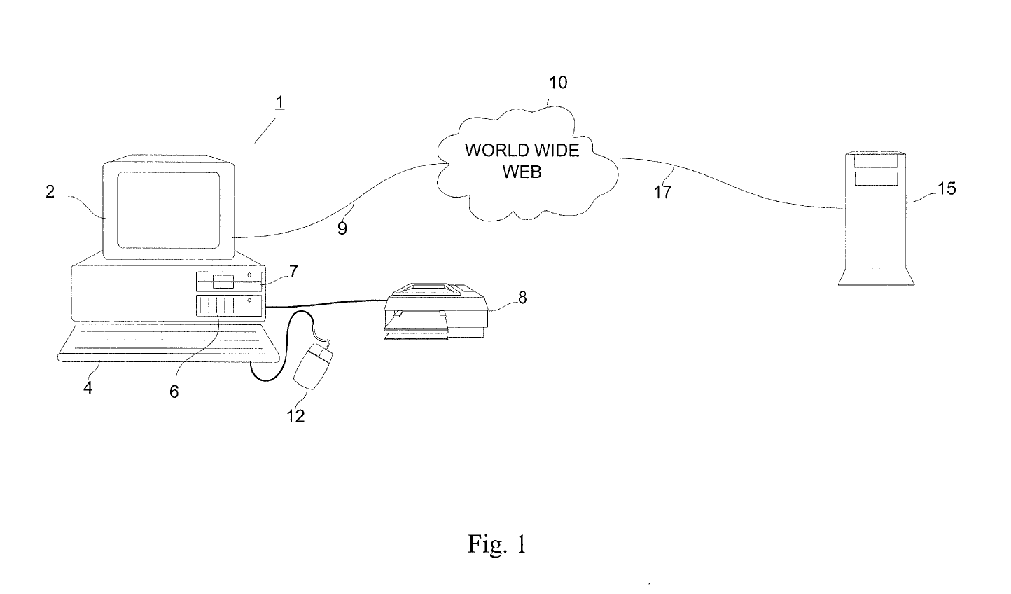

FIG. 1 is an outward view of representative computing hardware embodying the present invention. Shown in FIG. 1 are computer 1 executing a browser-enabled operating system, such as Microsoft Windows98®, display monitor 2 for displaying text and images to a user, keyboard 4 for entering text and commands into computer 1, and mouse 12 for manipulating and for selecting objects displayed on display monitor 2. Also included with computer 1 are fixed disk drive 6, in which are stored application programs, such as a World Wide Web browser application, data files, and device drivers for controlling peripheral devices attached to computer 1, floppy disk drive 7 for use in reading data from and writing data to floppy disks inserted therein. Data and/or applications may also be accessed from a CD-ROM via a CD-ROM drive (not shown) or over a network, such as World Wide Web 10, to which computer 1 is connected. Computer 1 may be connected to one or more peripherals such as printer 8.

Computer 1 further includes a connection 9 to World Wide Web 10. While the invention is described with reference to the World Wide Web 10 (also referred to as the Internet), it should be apparent that the invention may be practiced with other types of networks such as an intranet, local area network, etc. Connection 9 may be formed, for example, via a serial modem (not shown) connected to computer 1 and a telephone line which, in turn, is connected to World Wide Web 10. It should be noted that computer 1 may be connected to World Wide Web 10 by other types of connections. By executing a web browser application, web pages and data can be received from World Wide Web 10 over connection 9 for display on monitor 2 and/or use by computer 1.

Also connected to World Wide Web 10, via a connection 17, is web server 15, which receives requests for web pages and/or data from such web browsers and/or other applications running on a client device such as computer 1 and sends the pages and/or data to a requesting application over World Wide Web 10. It should be apparent while only one server 15 is shown in FIG. 1, additional instances of server 15 may be used to store and reproduce data as described herein.

Web server 15 includes program code configured to receive requests and send responses to the requesting application to assist a user of computer 1 or other device to retrieve images using an encoded universal resource locator (URL) according to the present invention.

Like computer 1, web server 15 is a computing system that is preferably executing a browser-enabled operating system, such as Microsoft Windows98®, and may include a display monitor 2, keyboard 4 for entering text and commands and mouse 12 for manipulating and for selecting objects displayed on display monitor 2. Web server 15 further includes one or more disk drives (e.g., fixed disk drive 6, floppy disk drive 7 and/or a CD-ROM drive), in which are stored application programs, data, and device drivers for controlling peripheral devices.

A floppy disk drive, such as floppy disk drive 7 may be used to read data from and write data to floppy disks inserted therein. Data and/or applications may also be accessed from a CD-ROM via a CD-ROM drive (not shown) or over a network to which web server 15 may be connected (network connection not shown).

Web server 15 is connected to World Wide Web 10 via connection 17 which may be a serial modem or other interface (e.g., ethernet card) to connect directly or, indirectly, to the World Wide Web (or other communications network such as local or wide area networks). Connection 17 may be, for example, a telephone line, a T1 line, a local area network connection or the like. In a case that connection 17 connects directly to a local area network, the local area network is preferably connected to a router (not shown), which, in turn, is connected to World Wide Web 10. In such a configuration, the router includes firewall software for prevention of unauthorized access to the local area network.

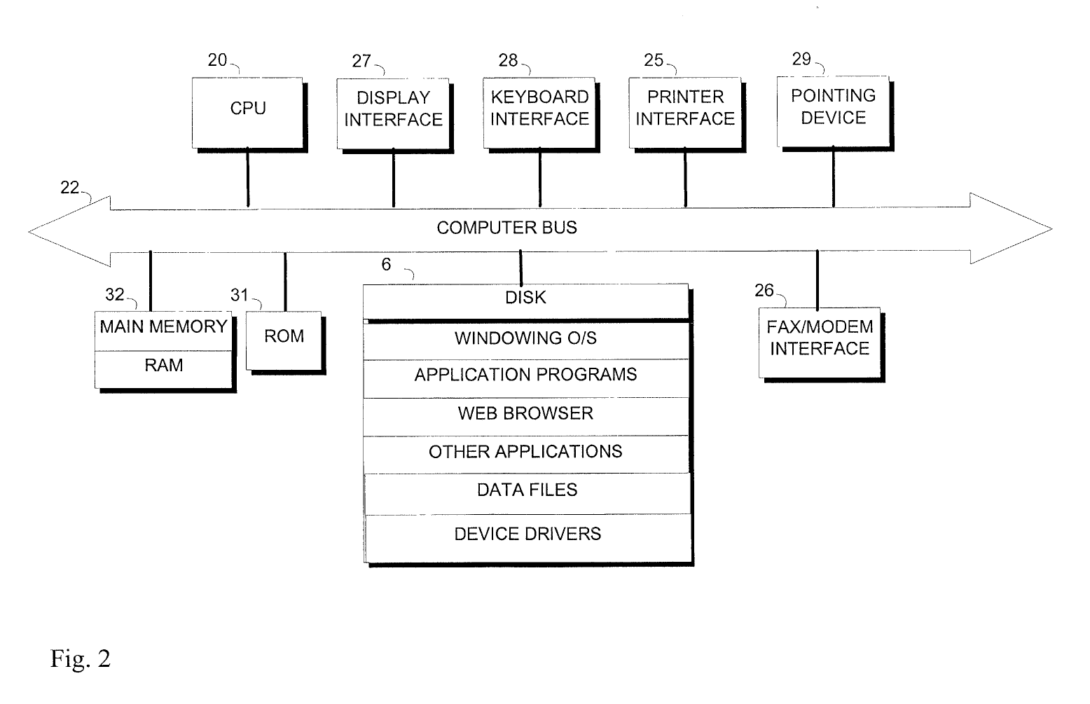

FIG. 2 is a block diagram of the internal architecture of computer 1. Shown in FIG. 2 are CPU 20, which is preferably a Pentium-type microprocessor, interfaced to computer bus 22. Also interfaced to computer bus 22 are printer interface 25, to allow computer 1 to communicate with printer 8, modem interface 26 to enable communications between computer 1 and its internal modem, display interface 27 for interfacing with display monitor 2, keyboard interface 28 for interfacing with keyboard 4, and mouse interface 29 for interfacing with mouse 12. Of course, if computer 1 connects to World Wide Web 10 by a connection other than a telephone connection, a suitable interface other than modem interface 29 may be utilized.

Read only memory (ROM) 31 stores invariant computer-executable process steps for basic system functions such as basic I/O, start up, or reception of keystrokes from keyboard 4.

Main random access memory (RAM) 32 provides CPU 20 with memory storage which can be accessed quickly. In this regard, computer-executable process steps of a web browser or other application are transferred from disk 6 over computer bus 22 to RAM 32 and executed therefrom by CPU 20.

Also shown in FIG. 2 is disk 6 which, as described above, includes a windowing operating system, a web browser executable on the particular windowing operating system, other applications which may include word processing, spreadsheet, graphics, gaming applications as well as applications downloaded from World Wide Web 10 (e.g., an interactive photo shop interface application). Disk 6 further includes data files and device drivers as shown.

The present invention may also be practiced using a set top box (STB) that, like computer 1, comprises a processing unit and memory and is capable of executing process steps. The STB typically uses a television set for output (e.g., to display a user interface) and a remote control with cursor keys as an input device. In addition, the STB interfaces with a cable head end (CHE) to receive broadband transmissions. Using a browser, the STB can send client requests to server software that executes on the CHE, or another sever.

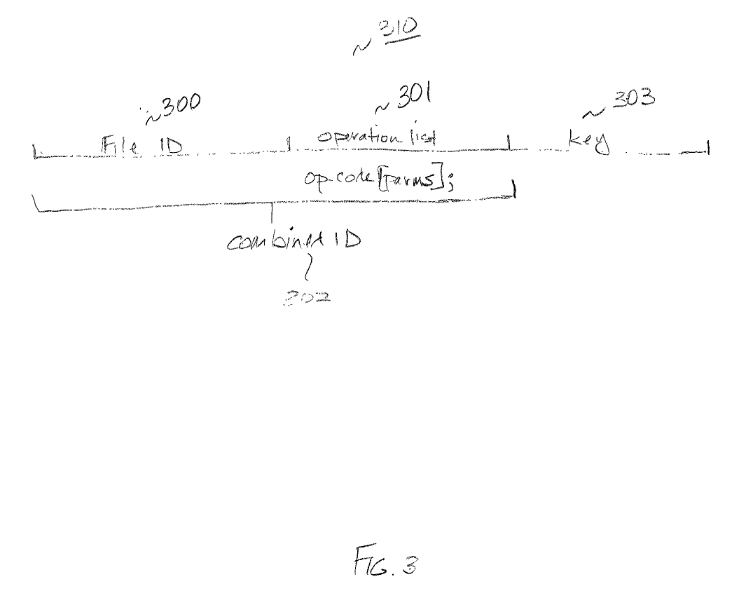

The present invention provides an encoded URL that may be used to request, or retrieve, a file. The file that is requested is described as an image file herein. However, it is possible that the present invention may be used with other types of files. FIG. 3 provides an overview of the structure of an encoded UTRL according to the present invention.

Encoded URL 310 comprises a file identifier (ID) 300, which may be a filename, or an identifier that may be used to generate a filename, of a file system. In addition, encoded URL 310 comprises operation list 301 that may be applied to the contents of the file pointed to by file ID 300. Combined ID 302 points to a location in which the result generated by applying operation list 301 to data. This location may be a location in cache, for example.

Thus, for example, when an image processing application is used to manipulate an image, the image is initially retrieved using file ID 300. As various operations are applied to the retrieved image, operations list 301 is updated with the operations that are performed on the image, and the manipulated image is stored in cache. Encoded URL 310, which comprises combined ID 302, may be used to retrieve the manipulated image from cache.

Encoded URL 310 may optionally include access key 303, which is used to validate a requestor's authorization to access an image referenced by combined ID 302. For example, if the contents of file ID 300, operation list 301, or both of encoded URL 310 are altered to attempt to access another image, access key 303 can be used to detect the alteration(s), and access can be denied. If access key 303 is found to be invalid, the access to either the initial image (pointed to by file ID 300) or the manipulated image (pointed to by combined ID 302) is denied.

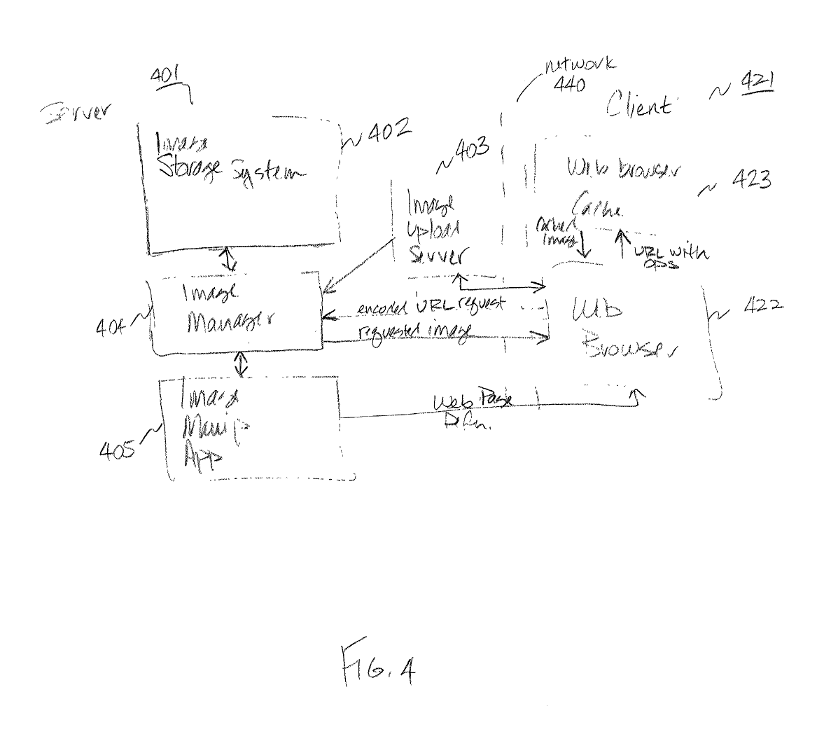

Encoded URL 310 of the present invention may be used in a web environment in which a client makes a request of a server for a file using encoded URL 310. FIG. 4 provides an example of an image processing client-server environment in which encoded URL 310 is used according to the present invention.

Server 401 comprises an image storage system 402, an image upload server 403, an image manager 404 and an image manipulation application 405. Client 421 communicates with server 401 via network 440 (e.g., World Wide Web 10, intranet, local area network, etc.). Client 421 comprises a browser 422 and browser cache 423.

Client 421 may upload images to server 401 using image upload server 403 and browser 422. In addition, browser 422 can be used to generate a user interface of image manipulation application 405 on client 421, which can be used to display and edit an image.

Images that are uploaded to image upload server 403 are managed by image manager 404, which is configured to store images in image storage system 402 and to use an encoded URL 310 to access images stored in image storage system 402.

Image storage system 402 comprises persistent storage as well as one or more levels of cache. A first level of cache may be used to store images such as the images that are uploaded to server 401 by client 421. A second level of cache is used to store proxy images of those stored in the first level cache. Proxy images are versions of the first level images that are frequently used (e.g., thumbnail image, display image, slide show image etc.).

A third level of cache is used to store an image from either the first or second level cache that has been manipulated (e.g., an image that has been manipulated using operation list 301).

When image manager 404 receives an image request that is made with encoded URL 310, it determines whether an image that corresponds to encoded URL 310 is stored in image storage system 402. If a corresponding image is stored in image storage system 402, image manager 404 retrieves the requested image and provides it to the requestor.

For example, image manipulation application 405 sends a web page definition (e.g., an Hypertext Markup Language, or HTML, file) to browser 422. As browser 422 parses the received page definition, it encounters a reference to an image such as that included in an “<IMG>” HTML element that includes encoded URL 310 as follows:

<IMG SRC=“ImageManager?imageID&op_list”>

In the above example, image manager 404 is identifies with encoded URL 310 has a parameter which is sent to image manager 404. The encoded URL 310 is comprised of “imageID&op_list”. The “imageID” portion corresponds to file ID 300 (e.g., which references a first or second level cached image), and the “op_list” corresponds to operation list 301. The “imageID” in combination the “op_list” comprise combined ID 302.

When image manager 404 receives the combined ID 302 indicated in the above example, it searches image storage system 402 (e.g., the third level of cache) to locate an image that corresponds to the combined ID 302. If such an image is not available in image storage system 403, image manager 404 causes the requested image to be generated using “imageID” and “op_list”. For example, image manager 404 can request that image manipulation application 405 generate the requested image by manipulating the image referenced by “imageID” using the operations specified by “op_list”. Image manager 404 in turn causes a response to be sent to browser 422 that includes the image requested by encoded URL 310.

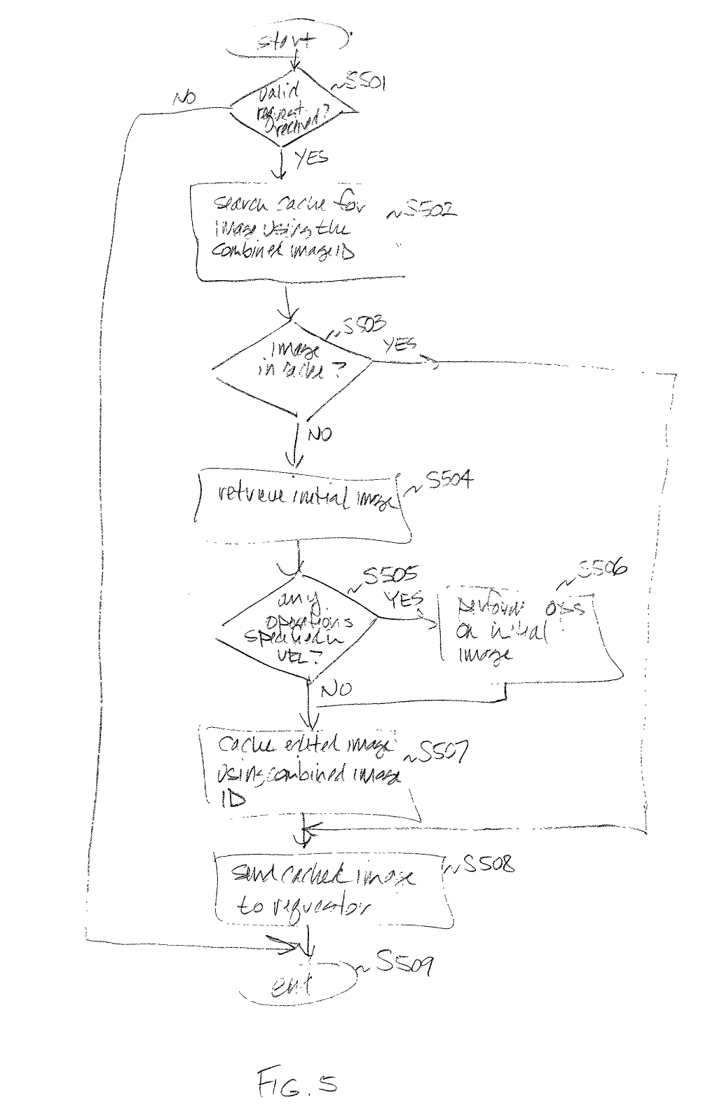

FIG. 5 illustrates a flow diagram of process steps to retrieve an image using encoded URL 310 according to the present invention.

At step S501, a determination is made whether or not a valid request has been received. Such a determination may include a determination that the request is authorized based on access key 303 of encoded URL 310. Generation and use of access key 303 is described in more detail below.

If it is determined, at step S501, that a valid request has been received, processing continues at step S502 to search cache (e.g., a cache that comprises a single level or multiple levels) for the requested image. At step S503, a determination is made whether the image is stored in cache. If not, processing continues at step S504 to retrieve an image using file ID 300. At step S505, a determination is made whether any operations are specified in operation list 301 of encoded URL 310. If not, encoded URL 310 is a request for the image referenced by file ID 300. Thus, if operations list 301 is empty, processing continues at step S507.

If there are operations in operation list 301, processing continues at step S506 to perform the operations, listed in operations list 301, on the image referenced by file ID 300. Processing continues at step S507 to cache the manipulated image.

At step S507, the image is stored in cache and, at step S508, the cached image is sent to the requester. Processing terminates at step S509.

According to the present invention, when image storage system 402 updates a cache with an edited image, an encoded URL 310 is associated with the cache entry. For example, when image manipulation application 405 edits an image, the edited image can be stored in cache of image storage system 402. Using browser 422, client 421 may cause image manipulation application 405 to perform one or more operations on an image (e.g., an initial or edited image). The resulting image is stored in image storage system 402 and an encoded URL 310 is associated with the cached image.

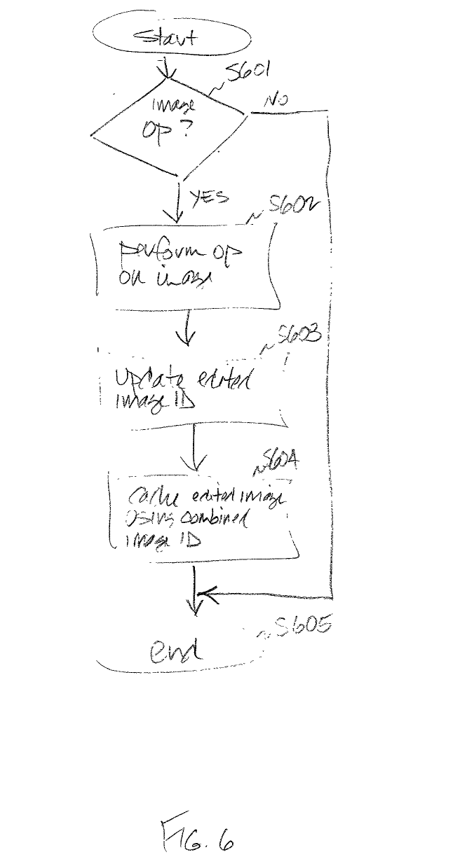

FIG. 6 illustrates a flow diagram of process steps to store an image with an associated encoded URL 310 according to the present invention.

At step S601, a determination is made whether an operation is to be performed on an image. If not, processing ends at step S605. If an operation is to be performed on an image, processing continues at step S602 to perform the operation. Steps S603 and S604 are performed in conjunction with storing an edited image (e.g., for storing an image in cache). At step S603, operation list 301 is updated to include an indication of the operation performed in step S602. The following provides an example of an operation list 301 according to the present invention:

“cr:400,400; r1”

In the above example of an operations list 301, two operations are specified. The “cr:400,400” portion specifies a cropping operation as well as the cropping area (i.e., “400,400”). In addition, operations list 301 indicates that the image is to be rotated once.

At step S604, the edited image is stored in cache using combined ID 302. Processing ends at step S605.

The operation that is performed in FIG. 6 may be a single operation, or more than one such as those operations listed in operation list 301. Further, an operation may be performed in response to a request by a user specified using an application's user interface (e.g., a user interface of image manipulation application 405), or may be performed based on a request for an image that is not stored in cache.

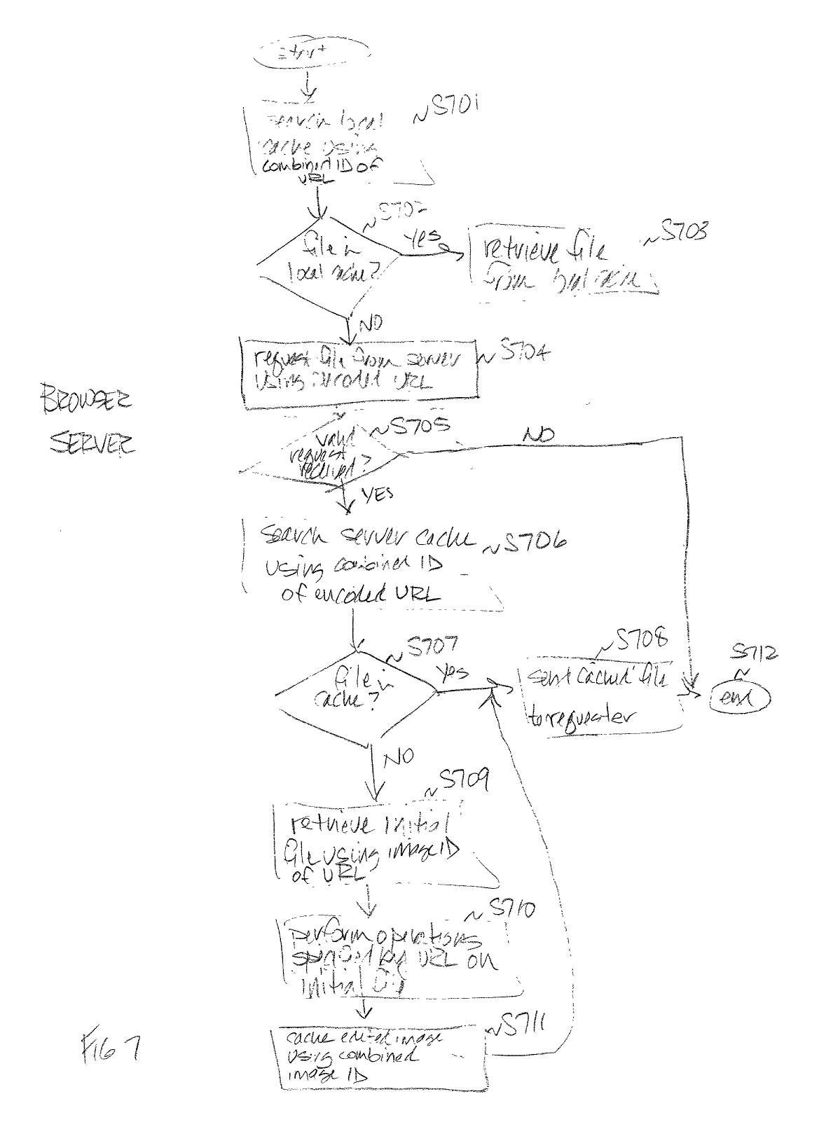

As discussed above, a request may be generated by browser 422 of client 421. FIG. 7 illustrates a flow diagram of process steps in which browser 423 sends an image request using encoded URL 310 to server 401 according to the present invention. Steps S701 to S704 are performed on client 421, and steps S705 to S711 are performed on server 401.

In step S701 on client 421, browser 422 searches local cache (e.g., browser cache 423) using combined ID 302. At step S702, a determination is made whether the requested image is available in browser cache 423). If the requested image is in browser cache 423, browser 422 retrieves the image from browser cache 423. However, if the requested image is not available in browser cache 423, browser 422 sends a request using encoded URL 310 to server 401.

In step S705 on server 401, a determination is made whether or not the request is valid. That is, encoded URL 310 is examined to ensure that it is in proper form. In addition, if authorization is required to access the requested image, access key 303 of the received encoded URL 310 is used to validate the request. If it is determined that the request is not valid, processing continues at step S712 to terminate processing of the request.

If the request is determined to be valid, processing continues at step S706 to search cache of image storage system 402 for the requested image using combined ID 302. At step S707, a determination is made whether a cached image exists. If so, the cached image is sent, at step S708, to the requester.

If the requested image is not stored in cache, processing continues at step S709 to retrieve the image referenced by file ID 300 of the encoded URL 310 contained in the request. At step S710, any operations that are specified in operations list 301 are performed on the image retrieved in step S709. At step S711, the image generated in step S710 is stored in cache. At step S708, the cached image is sent to the requester, and processing ends at step S712.

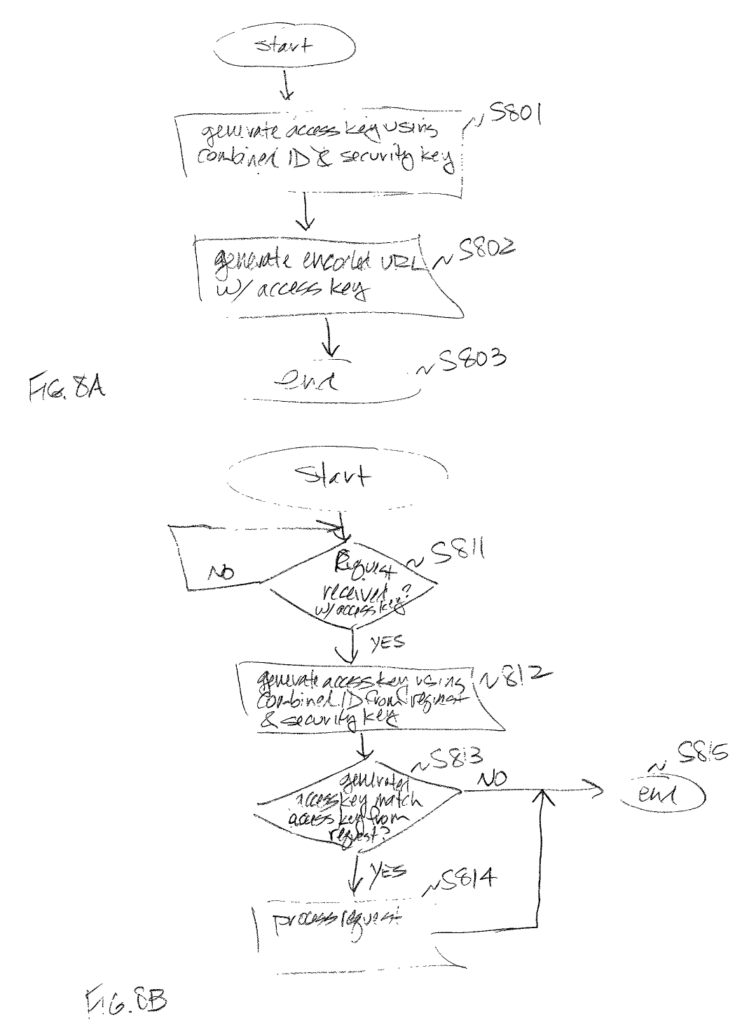

As discussed above, access key 303 may be used to validate a request using encoded URL 310. FIGS. 8A and 8B illustrate flow diagrams of process steps to generate access key 303 and to use access key 303 in validating a request according to the present invention. In the example of FIGS. 8A and 8B, access key 303 is generated by supplying combined ID 302 and a key to an MD5 key generation algorithm. However, any mechanism for generating a key may be used with the present invention. Knowledge of the contents of the key used with the MD5 algorithm is most preferably known only by a limited number of authorized persons.

Referring first to FIG. 8A, at step S801, access key 303 is generated using combined ID 302, a privately-known key, and the MD5 algorithm. At step S802, an encoded URL is generated using combined ID 302 and access key 303.

The encoded URL 301 generated in step S802 may be used to reference the image that corresponds to the encoded URL 310. For example, a user that has uploaded an image to server 401 may send the encoded URL 310 to other users (e.g., friends and relatives) so that the other users can request the same image. To limit access to only the image referenced by encoded URL 310, access key 303 may be used to validate a request that contains an encoded URL 310. Thus, if an attempt is made to request another image using a modified combined ID 302, access key may be used to validate the request.

Referring to FIG. 8B, at step S811, a determination is made whether an encoded URL 310 has been received. If so, processing continues at step S812 to generate an access key using combined ID 302 contained in the received encoded URL 310. At step S813, a determination is made whether the generated access key 303 matches the access key 303 in the received encoded URL 310.

If the generated access key 303 matches the received access key 303, the request is processed at step S814 as described herein. If it is determined that the generated access key 303 and the received access key do not match, the request is not fulfilled and processing ends at step S815.

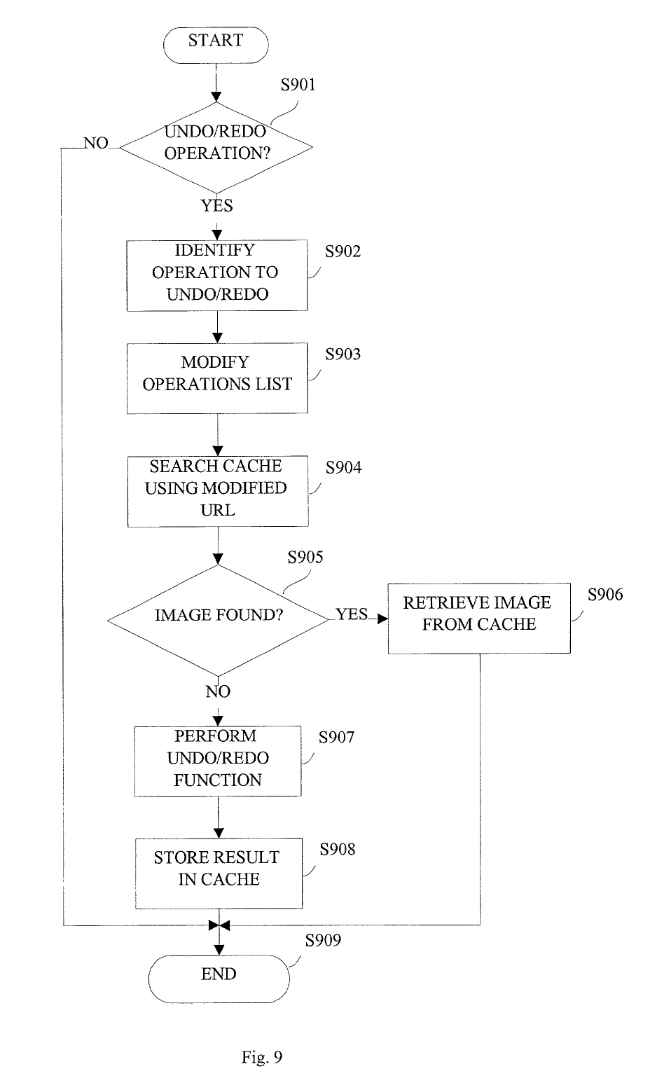

FIG. 9 illustrates a flow diagram of process steps for use in an undo/redo operation using encoded URL 310 according to the present invention.

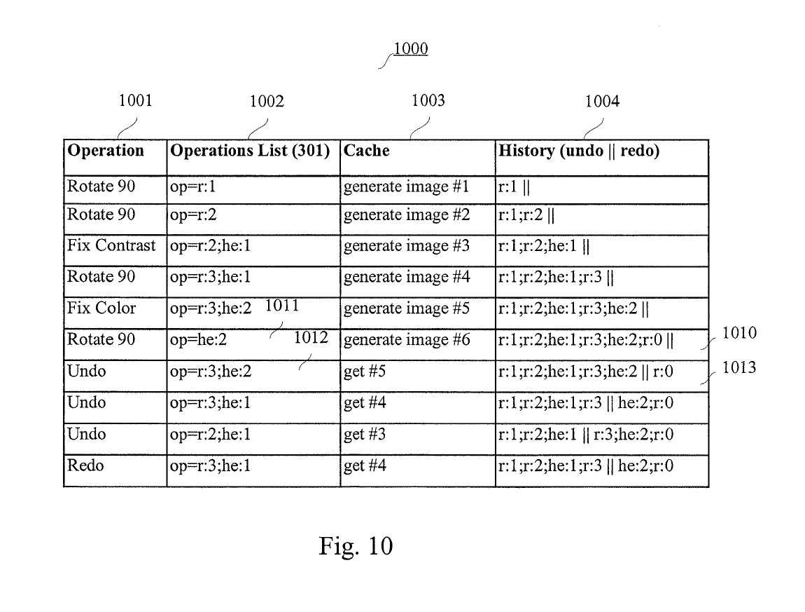

If it is determined, at step S901, that an undo/redo operation is to be performed, processing continues at step S902 to identify an operation that is to be undone/redone. According to the present invention, an operations history is maintained which is used to identify an operation to be undone or redone. FIG. 10 shows an example of operation history and operations list information for use in an undo/redo operation according to the present invention.

Table 1000 of FIG. 10 includes history 1004 which represents the information that is part of an operations history. Operations list 1002 shows the state of an operations list 301 as each operation in column 1001 is selected (e.g., by a user using image manipulation application 405). Column 1003 illustrates the operation that is performed as a result of the operation identified in column 1001.

For example, when a “Rotate 90” is performed as indicated in row 1010, operations list 1002 is updated (i.e., “op=r:1”) to reflect the rotate operation, image no. 1 is generated, and history 1004 is updated to reflect the rotate operation. The parallel bars in history 1004 reflect a pointer position. When the second “Rotate 90” operation is performed, operations list 1002 is updated (i.e., “op=r:2”) to reflect the second rotate operation. History 1004 is also updated (i.e., “r:1;r:2”) to reflect that a second rotate operation is performed.

The difference in the representation of the two rotate operations in operations list 1002 and history 1004 is based on an optimization in operations list 1002, primarily since operations list 1002 may be sent (as part of encoded URL 310) across the network. Two more rotate operations, a fix contrast operation and a fix color operation are performed before an undo operation is selected. Since the image has been rotated 360 degrees as a result of the four rotate operations, operations list 1002, at entry 1011, reflects only the fix contrast and fix color operations.

As described above, the determination at step S901 identifies that an undo operation has been selected, and processing continues at step S902 to identify the operation that is to be undone. Entry 1010, reflects the state of operations history 1004 prior to the undo operation. In entry 1010, the pointer is located to the right of the last rotate operation that was performed. It is determined at step S902 that the rotate operation is to be undone.

As a result of the determination at step S902, at step S903, the operations list 1002 is updated (entry 1012) to reflect a 270 degree rotation of the image. At step S904, the encoded URL 310, which includes modified operations list 301 (i.e., entry 1012), is used to search image storage system 402.

At step S905, a determination is made whether the image was found in image storage system 402. If so, the image is retrieved from image storage system in step S906. In the example of FIG. 10, image no. 5 is retrieved from cache using the modified encoded URL 310.

If the image was not found in image storage system, processing continues at step S907 to perform the undo operation. At step S908, the image that results from the undo operation is stored in image storage system 402 using the modified encoded URL 310. Processing ends at step S909.

In this regard, the invention has been described with respect to particular illustrative embodiments. However, it is to be understood that the invention is not limited to the above-described embodiments and that various changes and modifications may be made by those of ordinary skill in the art without departing from the spirit and the scope of the invention.

What is claimed is:

1. A resource locator data structure for use by a computer system to request a stored image, the data structure comprising:
a first portion comprising an identifier for accessing a first version of the image;
a second portion comprising a list of none or more operations, which when applied to the first image version yields a second version of the image,
wherein a combination of the first and second portions identify a requested image and the combination is used to determine whether the requested image exists in storage.

2. A data structure according to claim 1, wherein the operations list is empty, and the combination of the first and second portions yields the first image version.

3. A data structure according to claim 1, wherein the second version of the image is generated by applying the none or more operations to the first image version.

4. A data structure according to claim 1, wherein the combination comprises an identifier of the second image version, determining whether and the second image exists in storage further comprises:
searching local cache; and
searching persistent storage, if the second image version is not found in local cache.

5. A data structure according to claim 1, further comprising an access key.

6. A data structure according to claim 5, wherein the access key is derived from the first and second portions of the resource locator.

7. A data structure according to claim 5, wherein the access key is used to validate a request for the first image, the second image, or both using the resource locator.

8. A data structure according to claim 1, wherein the first image, the second image, or both are stored in a cache.

9. A data structure according to claim 8, wherein the cache is located on a client computer.

10. A data structure according to claim 8, wherein the cache is located on a server computer.

11. A method of referencing an image using a resource locator, the method comprising:
generating a first portion comprising an identifier associated with an image, the identifier referencing a first version of the image;
generating a second portion comprising a list of none or more operations, which when applied to the first image version yields a second version of the image,
wherein a combination of the first and second portions is used to reference the second image when it is found to exist in storage.

12. A method according to claim 11, wherein the operations list is empty, and the combination of the first and second portions yields the first image version.

13. A method according to claim 11, wherein the second version of the image is generated by applying the none or more operations to the first image version.

14. A method according to claim 11, wherein the combination comprises an identifier of the second image version, referencing the second image in storage further comprises:
searching local cache; and
searching persistent storage, if the second image version is not found in local cache.

15. A method according to claim 11, further comprising an access key.

16. A method according to claim 15, wherein the access key is derived from the first and second portions of the resource locator.

17. A method according to claim 15, wherein the access key is used to validate a request for the first image, the second image, or both using the resource locator.

18. A method according to claim 11, wherein the first image, the second image, or both are stored in a cache.

19. A method according to claim 18, wherein the cache is located on a client computer.

20. A method according to claim 18, wherein the cache is located on a server computer.

21. A method for retrieving an image in storage using a resource locator, the method comprising:
determining whether a requested image exists in storage, the requested image identified by information contained in the resource locator; and
retrieving an initial image identified by the resource locator and generating the requested image using the initial image and information contained in the resource locator, if the requested image is unavailable.

22. A method according to claim 21, wherein the resource locator comprises a list of none or more operations, which when applied to the initial image yields the requested image.

23. A method according to claim 22, wherein the operations list is empty, and the requested image is the same as the initial image.

24. A method according to claim 21, wherein the resource locator further comprises an access key.

25. A method according to claim 24, wherein the access key is derived from information contained in the resource locator.

26. A method according to claim 25, further comprising:
validating access to the requested image, the initial image, or both using the resource locator.

27. A method according to claim 21, wherein the request originates from a client network computer.

28. A method according to claim 27, wherein determining whether the requested image exists further comprises:
determining whether the requested image exists in cache of the client computer; and
determining whether the requested image exists in cache of a server computer, if the requested image is unavailable from the client computer's cache.
